(19) United States
(12) Patent Application Publication
(10) Pub. No.: US 2004/0240204 A1
(43) Pub. Date: Dec. 2, 2004

(54) Electric flare

(76) Inventors: Wray Russ, Brentwood, CA (US); Brandon Nicholas Russ, Brentwood, CA (US); John Arthur Roberts, Merced, CA (US)

Correspondence Address: BURNS DOANE SWECKER & MATHIS L L P, POST OFFICE BOX 1404, ALEXANDRIA, VA, 22313-1404, US

(21) Appl. No.: 10/449,311

(22) Filed: May 29, 2003

(51) Int. Cl. F21V 9/00

(52) U.S. Cl. 362/231

(57) ABSTRACT

An electric flare comprising a housing, an electric power source, and a plurality of light emitting sources connected to the electric power source, the light emitting sources arranged in a radial orientation in a planar arrangement on an exterior surface of the housing.

### FIELD OF THE INVENTION

The invention relates to an electric flare and safety light having a plurality of light emitting sources arranged in a radial orientation in a planar arrangement.

### DESCRIPTION OF THE RELATED ART

Road safety makers which are used for the purpose of diverting traffic around accidents, defining vehicular lanes, or indicating the presence of temporary hazards such as road work or disabled vehicles, are well known. The typical marker devices includes lightweight translucent traffic cones which may contain electric illumination, warning lamps which burn a heavy fuel such as Darien, and chemical flares which emit a highly visible flame.

The use of fuel burning lamps are diminishing because of the expense of the fuel, the potential fire hazards associated with its use, and the necessity to frequently replenish the fuel supply. For directing traffic around a work zone, traffic cones have become increasingly prominent; however, a traffic cone provides only limited visibility to the oncoming motorist at night or in inclement weather, such rain or snow.

Meanwhile, the use of chemical flares has traditionally been used for temporary hazards, such as vehicular breakdowns and traffic accidents. The typical chemical flare is often used to reroute traffic, or to direct traffic into specific lanes around an accident scene or work site. In the case of an accident, it is also often desirable for the chemical flares to be placed on the roadway as quickly as possible in order to avoid any further accidents, which requires the lighting of the chemical flare before placing the flare on the roadway. The lighting of a chemical flare is not only time consuming, but it can be extremely difficult in inclement weather such as high winds, rain, fog or snow.

Chemical flares also emit hazardous contaminants to the environment. A typical chemical flare contains hazardous materials like strontium nitrate, potassium perchlorate, and sulfur. During the burning of the flares, chemicals are emitted to the atmosphere, which primarily include sulfur dioxide, but also may contain other air contaminants such as nitrogen oxides, carbon monoxide, and carbon dioxide. As a result of the emission of hazardous materials, chemical flares also add emissions to ambient levels of air pollutants.

In addition, it is not uncommon for a chemical flare to pose an immediate hazard to police officers and motorists in close proximity of the location where the flares are burned, as a result of the burning of the chemicals which can not only ignite flammable materials on the roadway, but is also a danger to those who may come in contact with a burning chemical flare. Although functionally useful, the traditional chemical flares have several drawbacks, which include air pollution and safety hazards.

Chemical flares also have the disadvantage of being non-reusable and having a very short burn time. Typically, a chemical flare will burn between about 30 to 60 minutes before the flare needs to be replaced. Chemical flares are also quite expensive, including the Hazmat fee that is often included in the cost of the flare. The Hazmat fee helps with the clean-up of the chemical residue and pollutants which is left on the roadway. In addition, chemical flares are susceptible to the destruction of their effectiveness when struck or run over by passing vehicles.

Meanwhile, in the field of illumination devices, there has long been a trade-off between brightness and power conservation. It is known that the use of light emitting diodes (LEDs) consume substantially less power than incandescent light bulbs. However, typically, the radiant power of LEDs has been so limited so that they have been used for primarily short-range applications such as panel indicators or indoor signs.

However, one of the advantages of a LED is that the LED does not have a filament that will burn out. Accordingly, a LED will not only last much longer than an incandescent bulb, but additionally, their small plastic bulb makes them a lot more durable. In addition, a LED is more efficient than a conventional incandescent bulb, since the light-production process involving conventional incandescent bulbs requires that the filament must be warmed, which generates heat. Meanwhile, LEDs generate very little heat, relatively speaking since a much higher percentage of the electrical power is going directly to generating light, which cuts down on the electricity demands considerably.

Accordingly, what is needed is an electric flare which can be easily and quickly deployed. The electric flare is not only visible over a wide angle or field of view, but is also highly visible over a wide variety of conditions including day, night, rain, snow and/or fog.

### SUMMARY OF THE INVENTION

In accordance with one aspect of the present invention, an electric flare includes a housing; an electric power source; and a plurality of light emitting sources connected to the electric power source, the light emitting sources are arranged in a radial orientation in a planar arrangement.

In accordance with another aspect of the present invention, a flashlight; the flashlight includes a cylindrical housing; a cap; and a plurality of light emitting sources, wherein the light emitting sources are arranged in a radial orientation in a planar configuration.

In accordance with a further aspect of the present invention, a cap for a flashlight, the cap includes a cap; and a plurality of light emitting sources arranged in a radial orientation in a planar configuration.

In accordance with another aspect of the present invention, a dome-shaped electric flare, the dome-shaped electric flare, includes a dome-shaped housing; an electric power source; and a plurality of light emitting sources connected to the electric power source, the light emitting sources arranged in a radial orientation in a planar arrangement.

In accordance with a further aspect of the present invention, an electric flare includes a housing; an electric power source; and at least six light emitting diodes connected to the electric power source, wherein the light emitting diodes are radially are arranged in a substantially equal space around a 360 degree diameter of the housing.

### BRIEF DESCRIPTION OF THE DRAWING FIGURES

The invention will now be described in greater detail with reference to the preferred embodiments illustrated in the accompanying drawings, in which like elements bear like reference numerals, and wherein:

FIG. 1 is a perspective view of an electric flare according to the present invention.

FIG. 2 is a perspective view of an another embodiment of an electric flare according to the present invention in the form of a dome shaped flare.

FIG. 3 is a perspective view of an electric flare according to the present invention in the form of a flashlight.

FIG. 4 is a side view of a flashlight head according to one embodiment of the present invention.

FIG. 5 is a cross sectional view of the flashlight head of FIG. 4, including the flashlight housing.

FIG. 6 is a top view of the flashlight head of FIG. 4.

FIG. 7 is a cross-sectional view of a dome-shaped electric flare according to the present invention in the form of a dome-shaped flare fixed to a hat.

### DETAILED DESCRIPTION OF THE INVENTION

Referring to the drawings, wherein like numerals indicate like elements, an electric flare in accordance with the present invention is illustrated.

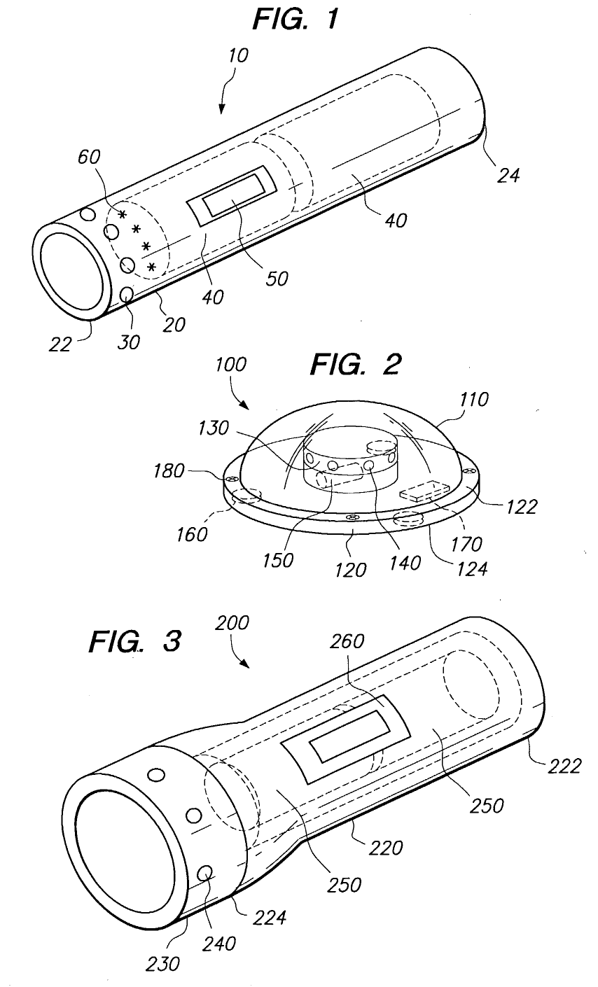

As shown in FIG. 1, generally designated by numeral 10 is an electric flare according to one embodiment of the invention. The electric flare 10 includes an elongated housing 20, an electric power source 40, and a plurality of light emitting sources 30. The light emitting sources 30 are arranged in a radial orientation in a planar arrangement. The light emitting sources 30 preferably provide omni-directional viewing.

The elongated housing 20 has a first end 22 and a second end 24, the housing 20 defining a cylindrical bore therein. The housing 20 is preferably cylindrical, having a top, a bottom, and a side surface. It can be appreciated that the housing 20 can be rectangular or oval without departing from the general idea of the present invention.

The electric flare 10 is preferably made of a material that is waterproof, shockproof, vibration proof, and resist chemicals like jet fuels, gasoline, diesel fuel, road salts, and chlorine. In one preferred embodiment, the housing 20 is preferably constructed of a plastic such as polyvinyl chloride (PVC), polycarbonate, polyethylene, polypropylene, polyurethanes, unsaturated polyesters, epoxies and ABS (acrylonitrile, butadiene and styrene). The housing 20 preferably will be opaque, and most preferably white. The housing 20 can also include indicia 60 for aesthetic appearance, marketing purposes, and/or directions for operation and use.

The plurality of light emitting sources 30 are arranged in a radial orientation toward the first end 22 of the housing 20. The light emitting sources 30 are preferably arranged in a radial orientation, wherein each of the light emitting sources are on a single plane. Preferably, the light emitting sources 30 are arranged in a substantially equal space around a 360 degree diameter of the housing 20. In a one embodiment, eight light emitting sources 30 are arranged in the radial configuration on the side surface of the housing 20. However, it can be appreciated that between about four and sixteen light emitting sources can be used depending on the size of the light emitting sources 230 and the circumference of the housing 20.

In one embodiment, the light emitting sources 30 are recessed into the housing 20, such that the light emitting sources 30 do not extent beyond an outer diameter of the housing 20. In one embodiment, the housing 20 does not allow light to be emitted axially.

The electric flare 10 also includes an electric power source 40 connected to the light emitting source 30. The power source 40 is preferably contained within the housing 20, and is preferably an electrical battery. The battery or batteries are preferably between about 0.5 and 60.0 volts, and more preferably about 1.5 volts per battery. It can be appreciated that the batteries can be rechargeable or one-time use batteries. In addition, alternative power sources can be used, including an external power supply, such as a cigarette lighter or an ICAD.

In one embodiment, the electric flare 10 includes a switch 50 for switching the electric flare 10 from a first position wherein the light emitting source 30 is not in electrical connection with the electric power source 40 to a second position wherein the light emitting source 30 is in electrical connection with the electric power source 40. The switch 50 is preferably located on the housing 20 of the flare 10. The switch 50 is preferably a slide switch, however, it can be appreciated that the switch can be a rocker switch, toggle switch, rotary switch, detector switch, key-lock switch, snap-action switch, a link switch, photocell, or push-button switch.

In one embodiment of the present invention, the light emitting source 30 is a semiconductor light source such as a light emitting diode (LED). It can be appreciated that other light emitting sources can be used including but not limited to incandescent bulbs and fiber optics.

In the practice of this invention, it is preferred that the light emitting source 30 is selected with a wavelength in the red-orange-amber color range. However, it can be appreciated that light emitting sources which transmit light in the blue, green, and white colors ranges may also be utilized in the present invention. In addition, it is preferred that the light emitting source 30 provide constant illumination. However, in an alternative embodiment, the light emitting source 30 can have a flashing or an on and off appearance.

Preferably, commercially available LEDs in sizes ranging from T1 to T4, with T1 ¾ being the most preferred for purposes of this invention. Commercially available LEDs with red lamps typically exhibit luminous intensity of at least 2000 millicandela, while amber lamps typically exhibit luminous intensity of at least 1000 millicandela. It is most preferable, for purposes of the present invention to utilize LEDs with luminous intensities of at least 1000 millicandela.

As shown in FIG. 2, generally designated by numeral 100 is an alternative embodiment of an electric flare according to the present invention in the form of a dome-shaped flare. The dome-shaped flare 100 includes a cover 110, a base 120, a board 130 for receiving a plurality of light emitting sources 140, an electric power source 150, and a switch 170. The light emitting sources 140 are preferably arranged in a radial orientation in a planar configuration.

The cover 110 preferably has a dome like shape or appearance and is attached to a base 120. The cover 110 is preferably fixed by a plurality of screws 180 so that the cover 110 can be removed. It is preferable that the plurality of light emitting sources 140 and power source 150 are replaceable. However, it can be appreciated that the cover can be welded, cemented, glued, adhesives, or other similar attachment processes. The cover 110 is preferably a clear, crush resistant plastic, such as polyvinyl chloride (PVC), polycarbonate, polyethylene, polypropylene, polyurethanes, unsaturated polyesters, epoxies and ABS (acrylonitrile, butadiene and styrene). Preferably, the flare 100 can withstand the weight of an automobile or truck if accidentally run over.

As shown in FIG. 2, the base 120 has a generally circular shape having a first surface 122 and a second surface 124. The cover 110 is fixedly attached to the first surface 122. In one embodiment, a plurality of supports 160 are fixedly attached to the second surface 124. The base 120 is preferably formed of materials of a plastic or metal alloy. In a preferred embodiment, the base 120 is formed of stainless steel.

The light emitting sources 140 are preferably attached on a board 130 in a radial orientation in a planar arrangement. The board 130 has a generally circular shape for receiving the plurality of light emitting sources 130. The light emitting sources 130 are preferably light emitting diodes (LEDs).

In one embodiment, the electric flare 100 includes a power switch 170 for switching the electric flare 100 from a first position wherein the light emitting source 140 is not in electrical connection with the electric power source 150 to a second position wherein the light emitting source 140 is in electrical connection with the electric power source 150. The power switch 170 is preferably located on the second surface 124 of the base 120 of the flare 100. However, it can be appreciated that the power switch can be located anywhere on the dome-shaped flare 100. The switch 170 is preferably a slide switch, however, it can be a rocker switch, toggle switch, rotary switch, detector switch, key-lock switch, snap action switch, link switch, photocell, or push-button switch.

As shown in FIG. 3, generally designated by numeral 200 is a flashlight having a cylindrical housing 220, a cap 230, and a plurality of light emitting sources 240. The light emitting sources 240 are arranged in a radial orientation in a planar configuration. The housing 220 preferably contains an electric power source 250 therein. The light emitting sources 240 are electrically connected with the power source 250. In a preferred embodiment, a switch 260 is provided to turn the light emitting sources 240 from a first position, where the light emitting sources 240 are not in electrical connection with the electric power source 250, to a second position, where the light emitting sources 240 are in electrical connection with the electric power source 250.

The housing 220 is preferably an elongated cylinder having a first end 222 and a second end 224. The second end of the housing 220 preferably includes a series of threads on an exterior surface of the housing 220. The cap 230 includes a series of threads on an interior surface of the cap 230 for mating with a series of threads on the exterior surface of the housing 220. In operation, the cap 230 is preferably threaded onto the second end 224 of the housing 220.

The cap 230 includes a plurality of light emitting sources 240 arranged in a radial orientation in a planar arrangement on the exterior surface of the cap 230. In a preferred embodiment, 8 light emitting sources are arranged in the radial configuration. The 8 light emitting sources 240 are preferably connected to the electric power source 250, wherein the light emitting sources 240 are radially arranged in a substantially equal space around a 360 degree diameter of the cap 230. However, it can be appreciated that between about 4 and 16 light emitting sources can be used depending on the size of the light emitting sources 240 and the circumference of the cap 230.

In a preferred embodiment of FIG. 3, the light emitting source 240 is a light emitting diode (LED).

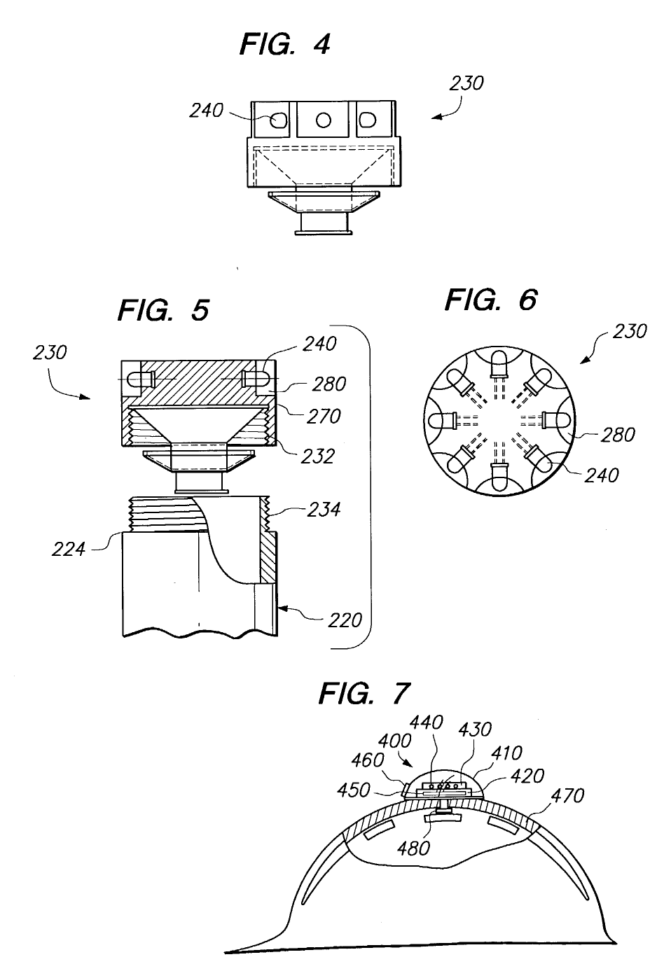

FIG. 4 is side view of the cap 230 of a flashlight according to one embodiment of the present invention. As shown in FIG. 4, the LEDs are arranged in a radial orientation in a planar arrangement.

The cap 230 preferably includes a translucent or clear plastic head for improved visibility. More preferably, the translucent material will have a hardness, wherein the cap is able to withstand the weight of an automobile or truck having a gross weight of not less than about 10 tons.

The flashlight cap 230 is preferably manufactured with a series of threads 232 which will accommodate a housing of a standard flashlight. Accordingly, the cap 230 can be sold separately and used with a standard flashlight. It can also be appreciated that the flashlight 200, including cap 230, can be manufactured and sold in both standard sizes and mini lights.

In an alternative embodiment, the flashlight 200 is activated by threading the cap 230 onto the second end 224 of the housing 220 causing a connection between the power source 250 and the light emitting source 240.

FIG. 5 is a cross section of FIG. 4 taken along the line A-A. As shown in FIG. 5, the light emitting sources 240 are preferably recessed into the cap 230 so that the light emitting sources 240 do not extend beyond an exterior surface 270 of the cap 230 of the flashlight 200. The cap 230 is preferably made of a molded plastic wherein the LEDs are embedded into the cap 230. As shown in FIG. 5, the light emitting source 240 is embedded into the cap 230 and includes a plurality of cut outs 280 which are then covered with a clear or translucent material.

The cap 230 has a series of threads 232 on an interior surface of the cap 230 for mating with a series of threads 234 on an exterior surface of the cylindrical housing 220 of the flashlight 200.

The housing 220 and the cap 230 are preferably constructed of a plastic, such as polyvinyl chloride (PVC), polycarbonate, polyethylene, polypropylene, polyurethanes, unsaturated polyesters, epoxies and ABS (acrylonitrile, butadiene and styrene). The material selected for the housing 220 and the cap 230 preferably provides a flashlight 200 which is shock and vibration proof, as well as weatherproof.

FIG. 6 is a top view of the cap 230. As shown in FIG. 6, the light emitting sources 240 are arranged in a radial orientation, preferably having at least 6 light emitting sources 240 in a planar arrangement, and more preferably 8 light emitting sources.

In another embodiment of the present invention, the electric flare 400 can be positioned on the top of a helmet or hard hat. Preferably, as shown in FIG. 7, the electric flare 400 includes a cover 410, a base 420, a board 430 for receiving a plurality of light emitting sources 440, a power source 450, and a switch 460. The light emitting sources 440 are preferably arranged in a radial orientation in a planar configuration. Preferably, the light emitting sources 440 are light emitting diodes.

The electric flare is fixed to a helmet or hard hat 470 by a combination of a nut-and-bolt 480 positioned on top of the helmet 470 and extending through the top of the helmet 470. It can be appreciated that the electric flare can be fixed to the top of the helmet by other means including a flexible band, epoxy, adhesives, clamps, or any other known means for securing an item to a hard had or helmet.

While the invention has been described in detail with reference to the preferred embodiments thereof, it will be apparent to one skilled in the art that various changes and modifications can be made and equivalents employed, without departing from the present invention.

What is claimed is:

1. An electric flare comprising:
a cylindrical housing, the housing having a top, a bottom, and a side surface;
an electric power source; and
a plurality of light emitting sources connected to the electric power source, the light emitting sources arranged in a radial orientation in a planar arrangement on the side surface of the housing.

2. The electric flare of claim 1, wherein the light emitting source is a semiconductor light source.

3. The electric flare of claim 2, wherein the semiconductor light source is a light emitting diode (LED).

4. The electric flare of claim 1, further comprising a switch for connecting an electric circuit between the light source and the power source.

5. The electric flare of claim 3, wherein the light emitting diodes are reddish in color.

6. The electric flare of claim 1, further comprising a dome-shaped cover.

7. The electric flare of claim 6, wherein the dome-shaped cover is made of a translucent material.

8. The electric flare of claim 1, wherein the housing is a flashlight having a closed first end and an open second end and a cap.

9. The electric flare of claim 8, wherein the plurality of light emitting diodes are in the cap.

10. The electric flare of claim 1, wherein the electric power source is contained within the housing.

11. The electric flare of claim 1, wherein the housing does not allow light to be emitted axially.

12. The electric flare of claim 1, wherein the plurality of light emitting sources is at least six.

13. A flashlight, the flashlight comprising:
a cylindrical housing;
a cap; and
a plurality of light emitting sources arranged in a radial orientation in a planar configuration.

14. The flashlight of claim 13, further comprising an electric power source contained within the cylindrical housing.

15. The flashlight of claim 13, further comprising a switch for electrically connecting an electric power source to the plurality of light emitting sources.

16. The flashlight of claim 13, wherein the cap has a series of threads on an interior surface of the cap for mating with a series of threads on an exterior surface of the cylindrical housing.

17. The flashlight of claim 13, wherein the plurality of light emitting sources is between about six and about ten.

18. The flashlight of claim 13, wherein the plurality of light emitting sources are embedded in the cap.

19. The flashlight of claim 13, wherein the light emitting source is a light emitting diode (LED).

20. A cap for a flashlight, the cap comprising:
a cap; and
a plurality of light emitting sources arranged in a radial orientation in a planar configuration.

21. The cap of claim 20, wherein the cap has a series of threads on an interior surface of the cap for mating with a series of threads on an exterior surface of a flashlight cylinder.

22. The cap of claim 20, wherein the light emitting source is a light emitting diode (LED).

23. The cap of claim 20, wherein the plurality of light emitting sources is between about six and about ten.

24. The cap of claim 20, wherein the plurality of light emitting sources are embedded in the cap.

25. A dome-shaped electric flare, the dome-shaped electric flare comprising:
a dome-shaped housing;
an electric power source; and
a plurality of light emitting sources connected to the electric power source, the light emitting sources arranged in a radial orientation in a planar arrangement.

26. The electric flare of claim 25, further comprising a switch for turning the electric flare on and off.

27. The electric flare of claim 25, further comprising a means for fixing the electric flare to hat.

28. The electric flare of claim 27, further comprising a nut and screw for fixing the electric flare to the hat.

29. The electric flare of claim 25, wherein the light emitting source is a light emitting diode (LED).

30. An electric flare, the electric flare comprising:
a cylindrical housing, the housing having a top, a bottom, and a side surface;
an electric power source; and
at least six light emitting diodes connected to the electric power source, wherein the light emitting diodes are radially arranged in a substantially equal space around the side surface of the housing.

31. The electric flare of claim 30, further comprising a switch for connecting a circuit between the light source and the power source.

32. The electric flare of claim 30, wherein the housing is a flashlight having a closed first end and an open second end and a cap.

33. The electric flare of claim 32, wherein the plurality of light emitting diodes are in the cap.
